(19) United States
(12) Patent Application Publication
(10) Pub. No.: US 2002/0136473 A1
(43) Pub. Date: Sep. 26, 2002

(54) Squeeze film damper bearing for gas turbine engine

(76) Inventor: Daniel Edward Mollmann, Cincinnati, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/815,758

(22) Filed: Mar. 23, 2001

(51) Int. Cl. F16C 27/00

(52) U.S. Cl. 384/99

(57) ABSTRACT

A squeeze-film damper bearing. Squeeze-film damper bearings contain a fluid film captured between two components, typically (1) a bearing race and (2) a housing which supports the race. The fluid film damps vibration of the two components. However, the fluid film also allows movement of the components with respect to each other, which is not always desired. The invention limits the movement, without significantly diminishing the vibration-damping properties of the fluid.

### FIELD OF THE INVENTION

The invention relates to fluid-film dampers which damp vibration of turbine engines.

### BACKGROUND OF THE INVENTION

FIG. 1 is a partial schematic view of a gas turbine engine 2, such as that used in a turbo-fan aircraft. A high speed rotor 3 contains a high-pressure compressor 6, a high-pressure turbine 9, and a shaft 12 connecting the compressor 6 with the turbine 9. A low-speed rotor 15 contains a fan 18, a low-pressure turbine 21, and a shaft 24 connecting the fan 18 with the turbine 21.

Bearings (not shown) support the two rotors 3 and 15. For example, one set of bearings may be located at the position indicated by dashed box 27, and allows the shaft 24 to support the high-speed rotor 3. A similar set may be located aft of this bearing set, which also supports the high-speed rotor 3.

Another set of bearings may be located at the position indicated by dashed box 30, and allows a schematic stationary structure 33 to support the low-speed rotor 15. A similar set may be located aft of this set, to further support the low-speed rotor. FIG. 2 is an exploded view of one type of bearing, which is shown in assembled form in FIG. 3, which may be located at dashed box 27 in FIG. 1.

In FIGS. 2 and 3, shaft 24 supports an inner race 36. Bearing rollers 39 separate the inner race 36 from an outer race 42. A bearing housing 45 is connected to the stationary structure 33 in FIG. 1, through a connection system which is not shown. The bearing housing 45 is separated from the outer race 42 by a space 46 in FIG. 3.

The apparatus of FIG. 3 also appears in FIG. 4, which also contains a cross-sectional view of the apparatus. In addition, piston rings 51 are shown at the right side of FIG. 4. The cell 52 is filled with oil (not shown), which acts as a damper.

The Inventor has identified one, or more, characteristics of the system of FIG. 4 which may be undesirable in certain situations.

### SUMMARY OF THE INVENTION

In a fluid-damped bearing of the type shown in FIG. 4, damper blocks, or spacers, are sometimes added between the outer race 42 and the bearing housing 45. The damper blocks limit travel of the outer race 42. However, the damper blocks are placed outside of cell 52, that is, outside the body of damping fluid. This placement provides two features: (1) a firm limit on movement of the outer race 42, with respect to the housing 45, and (2) a somewhat softer damping force, compared with certain other placements.

### BRIEF DESCRIPTION OF THE DRAWINGS

FIG. 1 is a partial schematic view of a gas turbine engine.

FIG. 2 is an exploded view of a bearing which can be used within dashed block 30 in FIG. 1.

FIG. 3 shows the bearing of FIG. 2 in assembled form.

FIG. 4 shows the bearing of FIG. 3, and also a cross-sectional view of part of the bearing, taken along arrows 4-4.

FIG. 5 is a view similar to that of FIG. 4, but containing stops 60.

FIG. 6 is collection of plots showing operating characteristics of three types of squeeze dampers, including one constructed according to the present invention.

FIG. 7 illustrates one form of the invention.

### DETAILED DESCRIPTION OF THE INVENTION

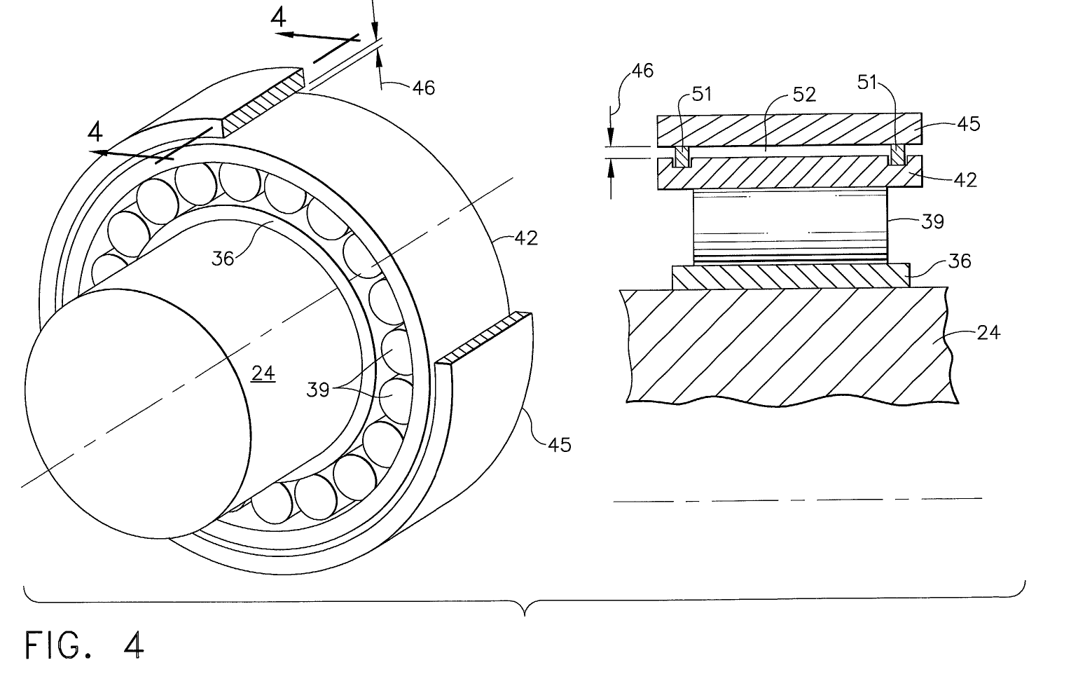

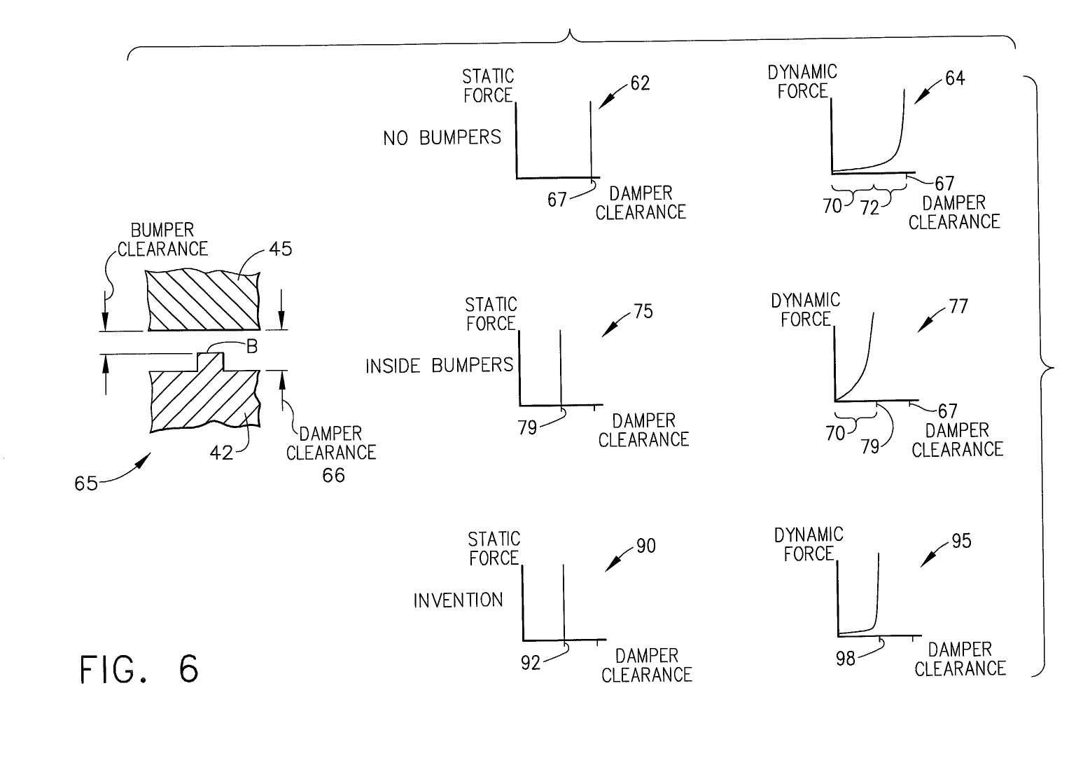

Prior to explaining the invention, some characteristics of the apparatus of FIG. 4, and a related apparatus, will first be explained. Behavior of the system of FIG. 4 is illustrated by plots 62 and 64 in FIG. 6. These plots are approximations. The damper radial clearance indicated in the plots is represented by dimension 66 in sketch 65. For the system of FIG. 4, the bumper B in sketch 65 is absent.

In plot 62, the static restoring force of the fluid in annular cell 52 in FIG. 4 is approximately zero, as damper radial clearance becomes reduced, and approaches limit 67. That is, when race 42 contacts housing 45 in sketch 65, damper radial clearance 66 reaches its minimal limit, represented by point 67 in plot 62. At this time, the static force becomes very large, because two solid bodies, namely race 42 and housing 45, are in contact, and oppose each other.

Plot 64 illustrates the dynamic damping force. This dynamic force is quite complex in nature, and becomes highly non-linear as the gap between race 42 and housing 45 closes.

The dynamic damping force of plot 64 is rather small in region 70. That is, the force of the fluid is analogous to a soft spring. In contrast, the opposing force in region 72 becomes rather large, partly because the fluid within chamber, or cell, 52 in FIG. 4 has become dimensionally thin when race 42 approaches housing 45. The term dimensionally thin is used to distinguish from thinness in the viscous sense.

Therefore, in the system of FIG. 4, the dynamic force of reaction between the race 42 and the housing 45 rapidly increases as the damper clearance 66 approaches its zero limit, represented by point 67 in plot 64.

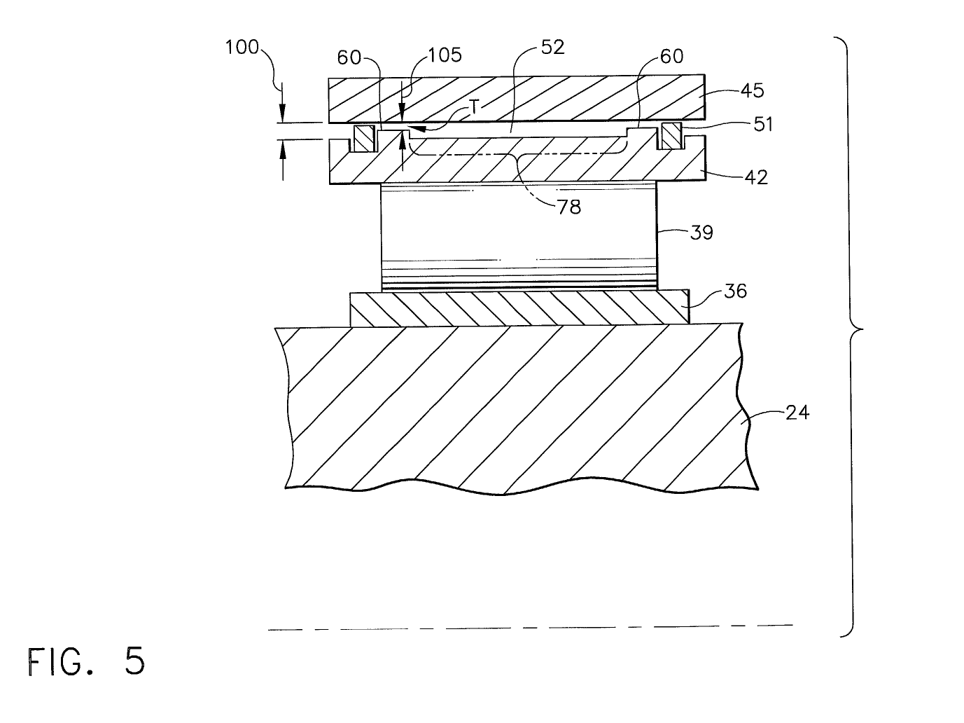

The plots 75 and 77 of FIG. 6 describe the behavior of a different system, namely, that of FIG. 5. In that Figure, stops, or bumpers 60, are provided, to limit travel of the race 42, with respect to the housing 45. In plot 75 in FIG. 6 for this system, one sees that the static opposing force, which tends to drive the race 42 in sketch 65 in that Figure to a central position within the housing 45, is approximately zero until point 79 is reached. At that time, bumper B contacts housing 45 in sketch 65.

In plot 77, one sees that the dynamic force fluid rapidly increases in region 70, compared with region 70 in plot 64. A primary reason for the rapid increase in plot 77 is that the fluid above bumper 60 becomes dimensionally thin sooner, as race 42 moves toward housing 45 in FIG. 5, compared with the situation in FIG. 4. The dimensionally thin fluid acquires the characteristics of a stiffer spring before damper radial clearance 66 in sketch 65 reaches zero.

In this connection, the Inventor points out an apparent paradox. In FIG. 5, the surface area of the top T of bumper 60 in contact with the fluid in annular cell 52 is much smaller than the surface area of the remainder of the annular cell 52, such as that indicated by bracket 78. One may think that the remainder would therefore dominate the behavior indicated by plot 77 in FIG. 6. However, the Inventor has uncovered evidence which indicates that this dominance is not present: the dynamic force is found to resemble that of plot 77.

Therefore, in the system of FIG. 5, travel of the race 42 is limited by bumpers 60. However, the bumpers 60 provide the stiff spring characteristic shown in plot 77 in FIG. 6. This characteristic may not be desirable in certain situations.

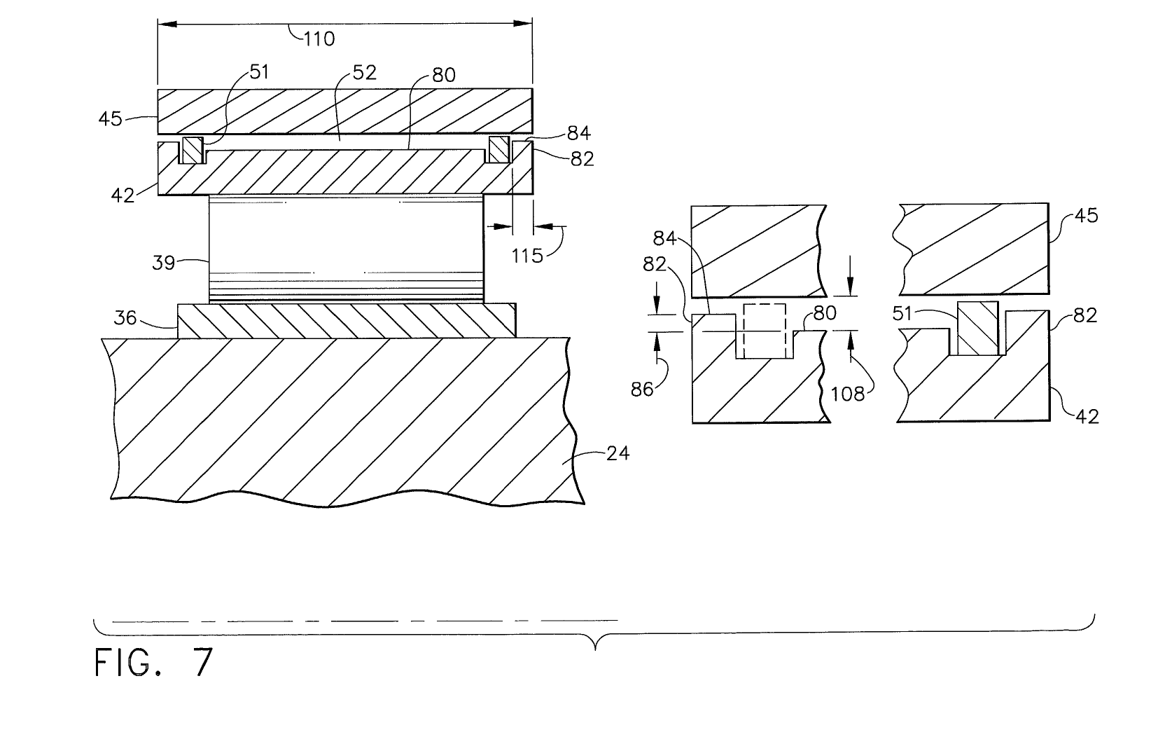

FIG. 7 illustrates one form of the invention. Bumpers 82 are provided. However, they are positioned outside annular cell 52. The bumpers 82 possess a radially outer surface 84, which is closer to housing 45 than the surface 80 of race 42 within the annular cell 52. Stated another way, outer surface 84 is radially taller than the inner surface 80 of the race 42.

The enlarged view shown at the right side of FIG. 7 illustrates this increased height of the outer surface 84 of bumper 82, compared with surface 80. The height of the bumper 82 is indicated by dimension 86.

Plots 90 and 95 in FIG. 6 illustrate the approximate behavior of the system of FIG. 7. In plot 90, static force is approximately zero, until point 92 is reached. At that point, surface 84 in FIG. 7 makes contact with housing 45.

In plot 95, the dynamic force follows a plot which is very similar to that of plot 64, until point 98 is reached in plot 95. Point 98 indicates contact between surface 84 in FIG. 7 and housing 45.

That is, under the invention, as the race 42 in FIG. 7 moves from its normal, rest position, toward the housing 45, the dynamic force follows a characteristic curve which is similar to that of plot 64 in FIG. 6. Restated, until point 98 is reached in plot 95, the dynamic damping force is very similar to that in a system wherein no bumpers B in sketch 65 are present. However, once point 98 is reached, both the static force in plot 90, and the damping force of plot 95, increase significantly.

Restated again, the invention provides the relatively soft dynamic spring force of plot 64, until the contact represented by point 98 is attained. The contact is between race 42 and housing 45.

Some generalized dimensions will now be given. Dimension 46 in FIG. 4 preferably lies between 5 and 20 mils. The term mil refers to a milli-inch, or 1/1,000 inch. Dimension 100 in FIG. 5 is preferably similar to dimension 46. In FIG. 5, dimension 105 preferably lies between 3 and 10 mils.

In FIG. 7, dimension 108 is similar to dimensions 46 and 100. Dimension 86 preferably lies between 2 and 10 mils.

In one embodiment, dimension 110 in FIG. 7 preferably lies between 1 and 2 inches. The axial width 115 of bumper 82 preferably lies between 0.05 and 0.1 inches.

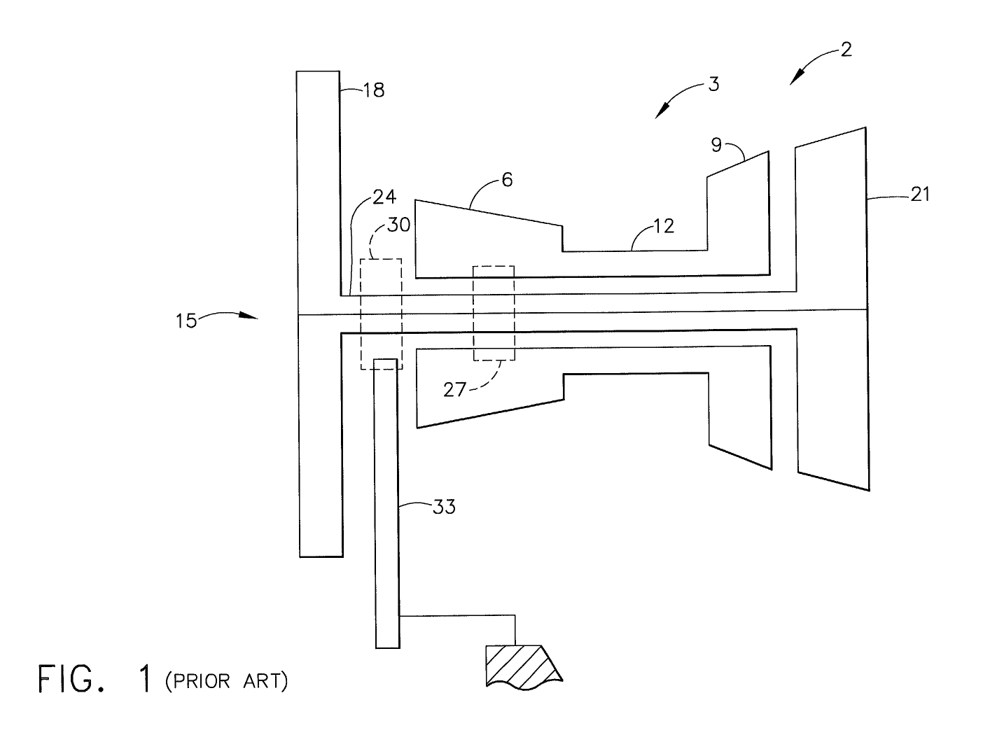

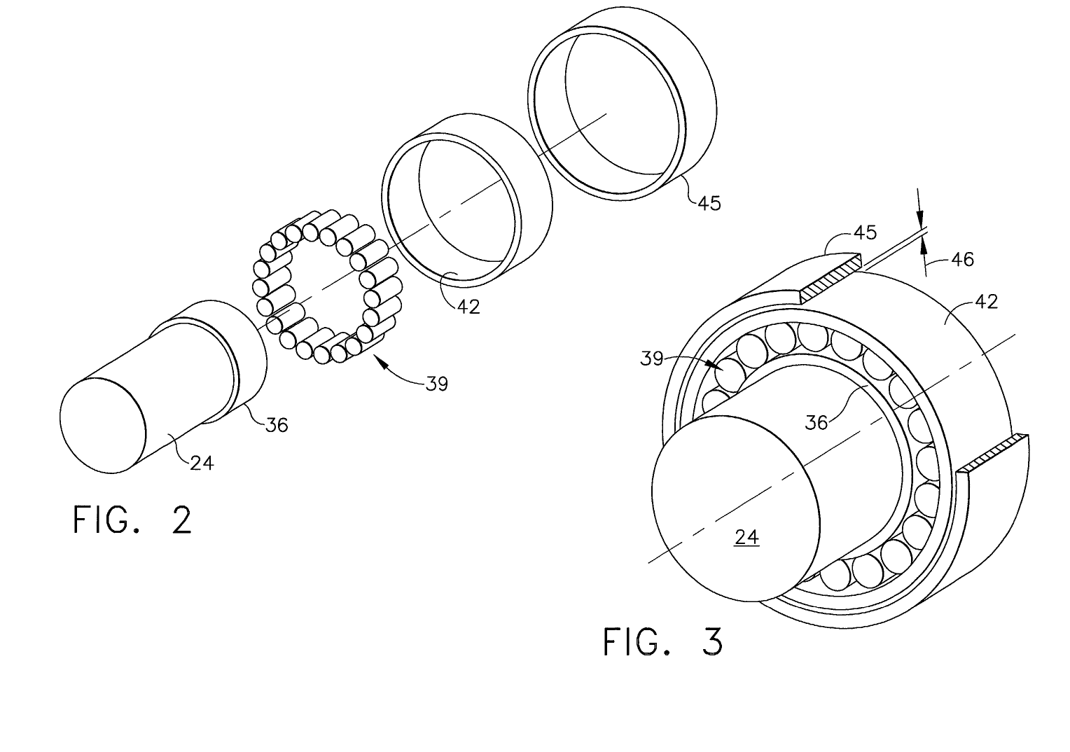

The invention was described in the context of one, or more, bearings which support the low-speed shaft 24 in FIG. 1, with the bearing itself being supported by stationary structure 33. Another application of the invention includes the bearing, or bearings, which support the high-speed shaft 12 in FIG. 1. Those bearings are supported by low-speed shaft 24.

A third application of the invention includes support of a single-shaft gas turbine engine. A fourth application would include all, or any combination of, shafts in a triple-shaft engine. A fifth application would include support of a high-speed shaft by a stationary structure.

Numerous substitutions and modifications can be undertaken without departing from the true spirit and scope of the invention. What is desired to be secured by Letters Patent is the invention as defined in the following claims.

1. Apparatus, comprising:
a) a bearing race within a housing, with a radial clearance therebetween;
b) an annular cell of damping fluid between the race and the housing, the fluid providing a damping force whose magnitude follows a characteristic curve as radial clearance changes; and
c) limit means for imposing a minimum limit on radial clearance, without altering the characteristic curve.

2. Apparatus acccording to claim 1, wherein the radial clearance changes during operation, and the maximum radial clearance is 10 mils.

3. Apparatus according to claim 1, wherein the radial clearance changes during operation, and the minimum radial clearance imposed by the limit means is 3 mils.

4. A system, comprising:
a) a squeeze-film damper bearing, which includes
i) a bearing race,
ii) an annular housing around the race, and
iii) a fluid separating the housing and the race, which
A) supports the race, and
B) provides damping to vibration in the race; and
b) a spacer which
i) imposes a limit on radial travel of the bearing race with respect to the annular housing, and
ii) does not affect damping of the fluid when the radial travel is below the limit.

5. System according to claim 4, and further comprising
c) seal means for cooperating with the race and the annular housing, for defining a chamber therebetween.

6. System according to claim 5, wherein the fluid is contained within the chamber.

7. System according to claim 5, wherein the seal means comprises at least one piston ring.

8. System according to claim 7, wherein the piston ring is seated in an annular groove in the race.

9. System according to claim 4, and further comprising a gas turbine engine, and wherein the system supports a rotor within the engine.

10. A system, comprising:
a) a gas turbine engine;
b) a rotor within said engine;
c) an annular housing connected to the rotor;
d) an annular bearing race surrounded by the annular housing;
e) sealing means for cooperating with the annular bearing race and the annular housing, for defining an annular chamber surrounding the annular bearing race;
f) a fluid within the annular chamber; and
g) a spacer, not in contact with the fluid, which limits travel of the race with respect to the housing.

11. System according to claim 10, wherein the sealing means comprises at least one piston ring.

12. System according to claim 11, wherein the piston ring is seated in an annular groove in the race.

13. Apparatus comprising:
a) a squeeze-film damper bearing, in which a radial clearance exists between a bearing race and a housing, which damper provides
i) a static restoring force to drive the bearing to a central position within the housing, and
ii) a dynamic force which damps vibration, and which follows a characteristic curve as radial clearance changes; and
b) a spacer which limits movement of the race with respect to the housing, without affecting the dynamic force.

14. A method, comprising:
a) maintaining a bearing race within a housing, with a radial clearance therebetween;
b) maintaining an annular cell of damping fluid between the race and the housing, the fluid providing a damping force which follows a characteristic curve as radial clearance changes; and
c) imposing a minimum limit on radial clearance, without altering the characteristic curve.

15. Apparatus, comprising:
a) a rotor containing a turbine for a gas turbine engine;
b) a fluid-film damper bearing for supporting the rotor, including:
i) a pair of parallel, coaxial piston rings, each having a radially inner face and a radially outer periphery;
ii) an annular bearing race in slidable contact with the radially inner faces;
iii) a support in contact with the outer peripheries;
wherein the piston rings, the bearing race, and the support define a cell, and wherein the bearing race can move with respect to the support, to thereby change the shape of the cell;
c) a damping fluid within the sealed chamber; and
d) a pair of spacers,
i) one adjacent one piston ring, and the other adjacent the other piston ring,
ii) neither spacer in contact with the damping fluid; and
iii) both of which limit travel of the bearing race with respect to the housing.

16. Apparatus according to claim 15, wherein the spacers do not affect dynamic damping force of the fluid.
